(19) United States
(12) Patent Application Publication
(10) Pub. No.: US 2025/0192567 A1
(43) Pub. Date: Jun. 12, 2025

(54) DISTRIBUTED RESOURCES MANAGEMENT APPARATUS AND DISTRIBUTED RESOURCES MANAGEMENT METHOD

(71) Applicant: HITACHI, LTD., Chiyoda-ku, Tokyo (JP)

(72) Inventors: Tetsushi ONO, Tokyo (JP); Ryousuke NAKAMURA, Tokyo (JP); Tsutomu KAWAMURA, Tokyo (JP)

(21) Appl. No.: 17/802,581

(22) PCT Filed: Sep. 29, 2020
(86) PCT No.: PCT/JP2020/036951

§ 371 Date: Jun. 27, 2023

(30) Foreign Application Priority Data
Feb. 26, 2020 (JP) 2020-030776

(51) Int. Cl. H02J 3/38; H02J 3/46

(52) U.S. Cl. CPC H02J 3/381; H02J 3/46; H02J 2203/10

(57) ABSTRACT

A distributed energy resources management system decomposes an optimization problem that minimizes or maximizes a cost index of distributed energy resources into a master problem having a linear constraint and a subproblem having a nonlinear constraint, the optimization problem being created from power system topology information, coupling busbar information on the distributed energy resources, and facility information on the distributed energy resources obtained from an energy resources management system. The distributed energy management system further estimates a new constraint condition for the master problem based on sensitivity information in a dual problem of the subproblem, adds the new constraint condition to a constraint condition of the master problem to limit a search area for a solution of the master problem, and computes a range of output combinations of distributed energy resources. The distributed energy management system further solves an optimization problem defined as the master problem based on the range of output combinations to calculate power generation amounts of the distributed energy resources, and outputs the calculated power generation amounts to the energy resources management system.

### CROSS-REFERENCE TO RELATED APPLICATIONS

This application is US National Stage of International Patent Application PCT/JP2020/036951, filed Sep. 29, 2020, which claims benefit of priority from Japanese Patent Application JP2020-030776, filed Feb. 26, 2020, the contents of both of which are incorporated herein by reference.

### TECHNICAL FIELD

The present application relates to a distributed energy resources management system and a distributed energy resources management method.

### BACKGROUND ART

Renewable energy power supplies (referred to as REPS, hereinafter), which emit no greenhouse effect gasses, are rapidly introduced to the bulk power system. However, the output of the REPS varies with the weather conditions, and this uncertainty hinders the REPS from becoming a reliable power supply source. In Europe, where the bulk power system spreads across borders, power can be imported and exported as a means against the output variation. On the other hand, in Japan, the supply-demand balance of power needs to be domestically adjusted, so that the problem of power system stability manifests itself at a relatively low REPS ratio (of 15 to 20%).

In the power distribution system, an increased number of distributed energy resources (referred to as DER, hereinafter), such as photovoltaics (referred to as PV, hereinafter), electric vehicles (referred to as EV, hereinafter) and combined heat and power systems (referred to as CHP, hereinafter), are expected to be introduced. Therefore, problems, such as voltage fluctuations and overcurrent due to reverse power flows of PV power, can arise in rural areas, while problems, such as overcurrent due to fast charging of EVs, can arise in urban areas.

For this reason, there is a demand for cooperation of DERs scattered in the power distribution system for providing a supply-demand balancing capability to the bulk power system and preventing voltage fluctuations and overcurrent in the power distribution system. Although the capacity of each DER is small, a collection of many DERs can provide a large capacity and contribute to power system stabilization. Thus, there is an increasing demand for a distributed energy resources management system (referred to as a DERMS, hereinafter), which is a platform on which a vast number of DERs can appropriately cooperate with each other.

The DER cooperation plan in the DERMS is defined as an optimization problem that minimizes an objective function, such as energy cost, and is determined by solving the optimization problem under device constraints of DERs. When all the characteristics of the DERs are linear, the optimization problem is a linear programming problem, which can be easily solved even if the problem is a large-scale optimization problem involving a large number of DERs. However, when there is a DER having nonlinear characteristics, such as a combined heat and power system, the optimization problem is a large-scale nonlinear programming problem, which is difficult to solve.

As a technique of efficiently solving a large-scale nonlinear programming problem involving a plurality of DERs, the technique described in Patent Literature 1 is known. In Patent Literature 1, it is described to “provide operation planning apparatus and method that can quickly calculate an overall optimization of reduction of the energy cost of power and heat of a microgrid formed by a plurality of sites, and local energy management apparatus and energy management apparatus used in the operation plan apparatus for the microgrid”.

### CITATION LIST

### Patent Literature

Patent Literature 1: Japanese Patent Laid-Open No. 2017-200311

### SUMMARY OF INVENTION

### Technical Problem

It is supposed that DERs scattered in the power distribution systems are owned by different operators. Of these operators, a power distribution system operator that is a public institution promises to achieve an overall optimization of the operation and receives the right to operate part of the capacity of the DERs from the DER operators. Therefore, the power distribution system operator must not arbitrarily manipulate the operation plan to benefit certain DER operators. Thus, the power distribution system operator needs to assure that the operation plan is an optimal solution or assure an error range with respect to the optimal solution.

In the power distribution system operator, whether to adopt the DER operation plan output from the DERMS is probably often determined by humans. Therefore, there is a need for disclosure of the reliability of the DER operation plan. For example, when the reliability of the solution output by the system is high, the solution can be used for the operation plan with security. To the contrary, when the reliability is low, it can be decided to use a past operation plan or otherwise take an alternative measure. As a means for evaluating the reliability, to what extent the objective function value of the solution output by the system deviates from the strict optimal solution can be indicated, for example.

However, the technique disclosed in Patent Literature 1 only outputs a DER cooperation plan and has no scheme for assuring that the plan is an optimal solution or assuring an error range with respect to the optimal solution.

The present invention has been devised in view of the circumstances described above, and an object of the present invention is to quickly compute an operation plan of each DER group, and another object is to assure the reliability of the operation plan.

### Solution to Problem

To solve the problems described above, according to an aspect of the present invention, a distributed energy resources management system includes: an optimization problem creation unit that creates an optimization problem that minimizes or maximizes a cost index of distributed energy resources from power system topology information, coupling busbar information on the distributed energy resources, and facility information on the distributed energy resources obtained from an energy resources management system, and decomposes the optimization problem into a master problem having a linear constraint and a subproblem having a nonlinear constraint; an output combination computation unit that estimates a new constraint condition for the master problem based on sensitivity information in a dual problem of the subproblem, adds the new constraint condition to a constraint condition of the master problem to limit a search area for a solution of the master problem, and computes a range of output combinations of distributed energy resources; and a power generation amount calculation unit that solves an optimization problem defined as the master problem based on the range of output combinations computed by the output combination computation unit to calculate power generation amounts of the distributed energy resources, and outputs the calculated power generation amounts to the energy resources management system.

### Advantageous Effects of Invention

According to the present invention, an operation plan of each DER group can be quickly computed, and the reliability of the operation plan can be assured, for example.

### BRIEF DESCRIPTION OF DRAWINGS

FIG. 1 is a block diagram showing an example general configuration of a system including a DERMS according to an embodiment 1.

FIG. 2 is a diagram showing an example of a power generation amount of each DER.

FIG. 3 is a diagram showing an example of DER coupling busbar information.

FIG. 4 is a diagram showing an example change of a search area due to an iterative computation using a Benders cut.

FIG. 5 is a diagram showing an example output of upper and lower bounds of an optimal solution.

FIG. 6 is a flowchart showing an example process of the DERMS according to the embodiment 1.

FIG. 7 is a block diagram showing an example general configuration of a system including a DERMS according to an embodiment 2.

FIG. 8 is a flowchart showing an example process of the DERMS according to the embodiment 2.

FIG. 9 is a block diagram showing an example general configuration of a system including a DERMS according to an embodiment 3.

FIG. 10 is a flowchart showing an example process of the DERMS according to the embodiment 3.

FIG. 11 is a diagram showing example hardware of a computer implementing the DERMS.

### DESCRIPTION OF EMBODIMENTS

Preferred embodiments of the present invention will be described below. In the following, like or similar elements or processing are denoted by like reference symbols, and redundant descriptions thereof will be omitted. Descriptions of each embodiment will be focused on differences from those described earlier than the embodiment, and redundant descriptions thereof will be omitted.

The components and processing shown in the following description and the drawings are intended to illustrate an overview of the embodiments required for the understanding and implementation of the present invention and are not intended to limit the implementation of the present invention. The embodiments and variations thereof can be partly or wholly combined as far as they are consistent with each other without departing from the spirit of the present invention.

### Embodiment 1

### <General Configuration of System Including DERMS 101 According to Embodiment 1>

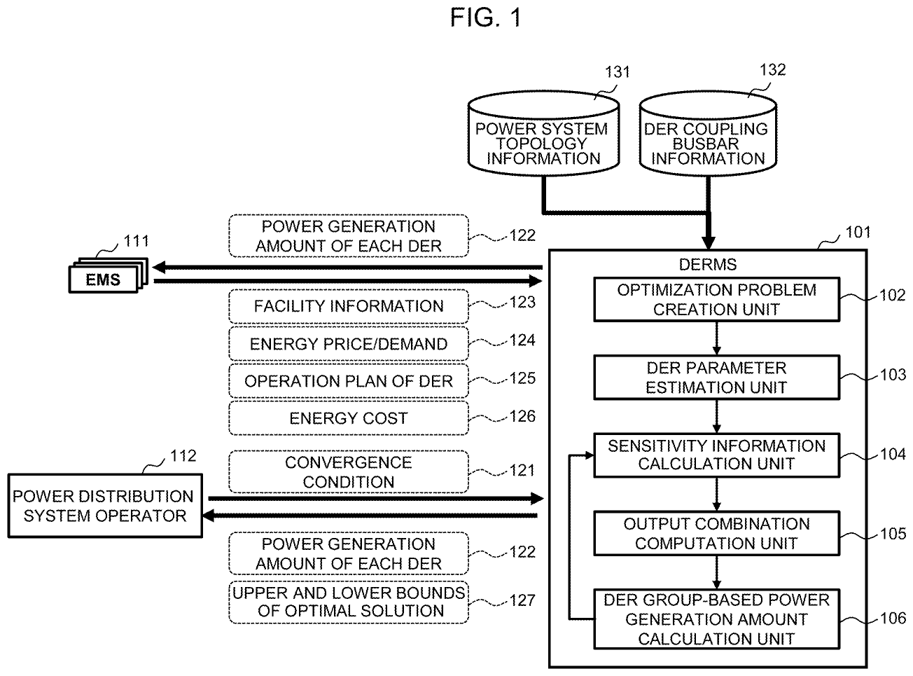

FIG. 1 is a block diagram showing an example general configuration of a system including a DERMS 101 according to an embodiment 1.

The DERMS 101 includes an optimization problem creation unit 102, a DER parameter estimation unit 103, a sensitivity information calculation unit 104, an output combination computation unit 105, and a DER group-based power generation amount calculation unit 106.

Inputs and outputs of the DERMS 101 will be described. The DERMS 101 first receives a convergence condition 121 from a power distribution system operator 112. The convergence condition 121 is an allowable range of the difference between an upper bound and a lower bound of an optimal solution, a calculation time for the bounds or an energy cost, or may be a combination of two or more of these. The DERMS 101 outputs a power generation amount 122 of each DER to an energy management system (EMS) 111. The power generation amount 122 in this step can be a provisional value.

The EMS 111 receives information such as the power generation amount 122 of each DER and an energy price/demand 124 as inputs, and determines an operation plan 125 of each DER and an energy cost 126 that minimize an energy cost that is an objective function. The objective function need not be the energy cost and may be any of various cost indices, and the operation plan 125 and the energy cost 126 of each DER may be determined so as to minimize the power transmission loss, minimize the amount of emissions of greenhouse effect gasses, maximize the power system stability, or maximize the amount of adjustment power reserved for an upper power system, for example.

In addition to facility information 123 on DERs to be controlled, the EMS 111 outputs the energy price/demand 124, and the operation plan 125 and the energy cost 126 of each DER, which are input/output data of the EMS 111, to the DERMS 101. The facility information 123 includes the types or number of the DERs controlled by the EMS 111, and the upper and lower limits of the output, the fuel consumption characteristics, the minimum continuous operation time, and the minimum continuous downtime of each DER, for example. The facility information 123 may be received from the EMS 111 in advance and stored in a database in the DERMS 101.

In the optimization problem creation unit 102 in the DERMS 101, a formula template for an optimization problem is prepared in advance. Examples of the formula template are the formulas (4) to (5) described later. The optimization problem creation unit 102 determines parameters in the formula template based on power system topology information 131 and DER coupling busbar information 132 of the power distribution system operator and the facility information 123 on DERs to be controlled obtained from the EMS 111, and outputs the created optimization problem.

However, all the EMSs 111 do not necessarily permit disclosure of the facility information 123 or the like, and therefore, input information to the optimization problem creation unit 102 may be insufficient, and an undetermined parameter may be output.

For example, if disclosure of the fuel consumption characteristics of a combined heat and power system, which is part of the facility information 123, is denied, parameters Aᵢ₃, Aᵢ₂, Aᵢ₁ and cᵢ in the formula (5) are undetermined. If disclosure of the upper and lower bounds of the output is denied, parameters Aᵢ₄ and cᵢ₄ in the formula (5) are undetermined. The undetermined parameters are estimated by the DER parameter estimation unit 103.

The DER parameter estimation unit 103 obtains the energy price/demand 124 and the operation plan 125 and the energy cost 126 of each DER, which are data used for parameter estimation, from the EMS 111.

As an example of the parameter estimation, when the parameters Aᵢ₃, Aᵢ₂, Aᵢ₁ and cᵢ in the formula (5) are undetermined, the parameters can be estimated by plotting the operation plans 125 and the energy costs 126 of each DER obtained in the past in a scatter diagram to define an approximate curve. When the parameters Aᵢ₄ and cᵢ₄ in the formula (5) are undetermined, the parameters can be estimated from the maximum value and the minimum value of the operation plans 125 of each DER obtained in the past.

For cooperation of the EMS 111 and the DERMS 101, a constraint referred to as the Benders cut described later is needed. To generate the Benders cut, sensitivity information on the sensitivity of each constraint to the objective function value is required. However, in general, the EMS 111 is not supposed to cooperate with the DERMS 101 and therefore probably has no function of calculating the sensitivity information. Thus, the sensitivity information calculation unit 104 estimates the sensitivity information. A method of estimating the sensitivity information will be described later.

The output combination computation unit 105 estimates the Benders cut expressed by the formula (10) described later based on the sensitivity information. The DER group-based power generation amount calculation unit 106 sets the Benders cut as a new constraint condition for the optimization problem of the formula (4), and solves the problem to calculate the power generation amount 122 for each DER. A new operation plan 125 and a new energy cost 126 of each DER are obtained by inputting the power generation amount 122 of each DER to the EMS 111 again. This computation is repeated and ended when the convergence condition 121 is satisfied, and the power generation amount 122 of each DER as the final computation result is output to the EMS 111 and the power distribution system operator 112. In addition, upper and lower bounds 127 of the optimal solution are output to the power distribution system operator 112.

There may be one or more EMS 111. The EMS 111 may control one or more DERs. The upper and lower bounds 127 of the optimal solution output to the power distribution system operator 112 are intended to assure the reliability of the operation plan and therefore may be other forms of information, such as a range of the optimal solution.

Although the DERMS 101 and the EMS 111 communicate and exchange information while the computation is repeated until the convergence condition 121 is satisfied in FIG. 1, a model of the EMS 111 may be created in advance in the DERMS 101, and the DERMS 101 may perform the convergence calculation while exchanging information with the model.

### <Power Generation Amount 122 of Each DER>

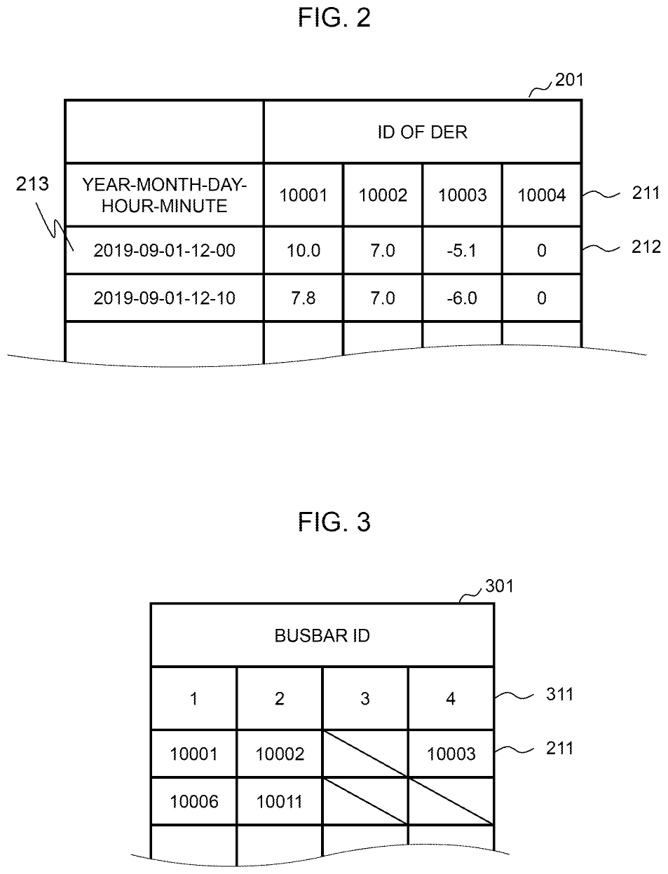

FIG. 2 is a diagram showing an example of the power generation amount 122 of each DER. A table 201 stores an ID 211 of a DER and a date and time 213, and retains a power generation amount plan 212 for the DER at each date and time 213 on a basis of the ID 211. The unit of the power generation amount plan 212 may be kWh, for example, and a negative value of the power generation amount means charging. As shown in the column of an ID 10004, the power generation amount can be indicated as 0 in a time zone in which there is no available capacity for power system stabilization or a time zone in which an EV is traveling and therefore cannot be controlled. Although the time interval in the table 201 is 10 minutes as an example, the present invention is not limited to this. Although the table 201 shows a case where there are four DERs as an example, the number of DERs is not limited to this.

Each DER is operated to meet the power generation amount 122 of the DER. In the case of an EV, the operation plan is how much the EV is charged or discharged in each time section (that is, a charge and discharge plan), so that the operation plan is uniquely determined if the power generation amount 122 of the DER is determined. On the other hand, in the case of a combined heat and power system, which handles not only power but also heat, the operation plan is not determined by only the power generation amount 122 of the DER. Therefore, the operation plan needs to be separately determined by the EMS 111.

### <DER Coupling Busbar Information>

FIG. 3 is a diagram showing an example of the DER coupling busbar information. A table 301 retains a busbar ID 311. The table 301 also retains an ID 211 of a coupled DER on a basis of the busbar ID 311. Some busbars, such as a busbar having a busbar ID=3, have no DER coupled thereto, and some busbars, such as a busbar having a busbar ID=4, have a smaller number of DERs coupled thereto than the other busbars Therefore, the table may have a blank field (indicated by a slash in the drawing).

Although the number of busbars is four in the table 301 as an example, the number of busbars is not limited to this. In addition, although the table 301 shows columns of busbar IDs 311 and the IDs 211 of the DERs coupled to each busbar, the table 301 may show columns of IDs 211 of DERs and the busbar IDs 311 of the busbars coupled to each DER. When a mobile DER, such as an EV, is considered, the table 301 may be dynamically modified.

In the following, as an example of the generation of a DER-cooperated operation plan, a case where the DERMS 101 handles the optimization problem expressed by the following formula (1) will be described. In the following, the formula (1) below will be referred to as an original problem, as required.

$$[ Formula 1 ]$$

$$Minimize Φ = {\sum }_{i = 1}^{N} {Φ}_{i} + {Φ}_{EV} \qquad ( 1 )$$

$$s . t .$$

$$power system constraint \qquad ( 1 - 1 )$$

$$device constraint of combined heat and power system \qquad ( 1 - 2 )$$

$$device constraint of EV \qquad ( 1 - 3 )$$

$$where$$

$$[ Formula 2 ]$$

$$ϕ : objective function of original problem ( = total sum of energy costs )$$

$${ϕ}_{i} : energy costs of combined heat and power system i$$

$$N : number of combined heat and power systems$$

$${ϕ}_{EV} : charging and discharging cost of all EVs$$

As shown by the above formula (1), the original problem is defined as an optimization problem that minimizes, as an objective function, the total energy cost expressed by the total sum of the energy costs of the combined heat and power systems and the charging and discharging costs of all the EVs. Each combined heat and power system is discriminated by a subscript i, while the EVs are not discriminated. The constraint conditions are constraints of the power flow, voltage or the like of a power distribution system, a device constraint of CHP, and a device constraint of EV. Although the EV and the combined heat and power system are described as examples of the DER in this embodiment, other DERs can also be used. The constraint conditions of the above formulas (1-1) to (1-3) can be defined by the following formulas (2-1) to (2-3).

$$[ Formula 3 ]$$

$$power system constraint : {A}_{PF} x \geq {c}_{PF} \qquad ( 2 - 1 )$$

$$device constraint of combined heat and power system i : \{ \begin{matrix}{A}_{i 3} {x}^{3} + {A}_{i 2} {x}^{2} + {A}_{i 1} x = {c}_{i} \\ {A}_{i 4} {x}_{SPi} x = {c}_{i 4}\end{matrix} \qquad ( 2 - 2 )$$

$$device constraint of EV : {A}_{EV} x \geq {c}_{EV} \qquad ( 2 - 3 )$$

$$where$$

$$[ Formula 4 ]$$

$$A : fixed matrix ,$$

$$c : fixed vector ,$$

$$x : optimization variable vector$$

The optimization variable vector x indicates the power generation amount of each DER (each EV or each combined heat and power system in this embodiment). The power system constraint and the device constraint of the EV have a linearity. When there are only linear constraints, a linear programming method can be used, and the calculation is simple. However, when the device constraint of the combined heat and power system, which has a nonlinearity, is considered, the whole problem needs to be solved as a nonlinear programming problem. In addition, the DERMS 101 typically devises operation plans of a vast number of DERs, so that the problem is a large-scale nonlinear programming problem, and directly solving the original problem takes an enormous amount of calculation time.

Although the characteristics of the combined heat and power system have been described as a cubic function as shown in the above formula (2-2), the characteristics of the combined heat and power system may be other functions, such as a quadratic function. Although the power system constraint has been described as being linear on the supposition of a power distribution system, the power system constraint may be a nonlinear constraint when the power system has a loop configuration. Although the charging and discharging characteristics of the EV have been described as being linear characteristics, the charging and discharging characteristics may be nonlinear characteristics when battery degradation characteristics are considered.

The terms of the objective function of the above formula (1) can be defined by the following formulas (3-1) to (3-2).

$$[ Formula 5 ]$$

$${Φ}_{i} = {b}_{i} x \qquad ( 3 - 1 )$$

$${Φ}_{EV} = {b}_{EV} x \qquad ( 3 - 2 )$$

$$where$$

$$[ Formula 6 ]$$

$${b}_{i} , {b}_{EV} : fixed vectors$$

In the following, A, b and c in the above formulas (2) and (3) will be referred to as parameter information. Parameter information A, b and c with a subscript CHP is combined heat and power system parameter information, parameter information A, b and c with a subscript EV is EV parameter information, and parameter information A, b and c with a subscript PF is power system parameter information.

Power systems and EVs are under the control of the DERMS 101, and therefore, it is considered that the EV parameter information and the power system parameter information are directly input to the DERMS. On the other hand, the operation plan of the combined heat and power system is devised by the EMS 111 cooperating with the DERMS 101, so that the DERMS 101 does not necessarily receive the combined heat and power system parameter information.

Thus, the DERMS 101 estimates the combined heat and power system parameter information based on the facility information 123 on DERs, and the energy price/demand 124 and the operation plan 125 and the energy cost 126 of each DER, which are input/output data of the EMS 111. Although it is assumed in this embodiment that the combined heat and power system is controlled by the EMS 111, other DERs than the combined heat and power system may be controlled by the EMS 111. In that case, the DERMS 101 estimates parameter information on the DER that is under the control of the EMS 111.

To efficiently solve the original problem, which is a large-scale nonlinear programming problem, the DERMS 101 uses the Benders decomposition to decompose the original problem into a master problem and a subproblem i (i denotes the ID of the combined heat and power system). The master problem is expressed by the following formula (4), and the subproblem i is expressed by the following formula (5). Other solving approaches than the Benders decomposition can also be used.

$$[ Formula 7 ]$$

$$Minimize {Φ}_{MP} = {\sum }_{i = 1}^{N} {Θ}_{i} + {b}_{EV} {x}_{MP} \qquad ( 4 )$$

$$s . t .$$

$$[ Formula 8 ]$$

$$power system constraint ( linear constraint ) : {A}_{PF} x \geq {c}_{PF} \qquad ( 4 - 1 )$$

$$device constraint of EV ( linear constraint ) : {A}_{EV} x \geq {c}_{EV} \qquad ( 4 - 2 )$$

$$non - negativity constraint of {θ}_{i} ( linear constraint ) : {θ}_{i} \geq 0 \qquad ( 4 - 3 )$$

$$where$$

$$[ Formula 9 ]$$

$${ϕ}_{MP} : objective function of master problem$$

$${x}_{MP} : optimization variable vector of master problem$$

$$[ Formula 10 ]$$

$$Minimize {Φ}_{{SP}_{i}} = {b}_{i} {x}_{{SP}_{i}} \qquad ( 5 )$$

$$s . t .$$

$$[ Formula 11 ]$$

$$fixation of optimization variable of master problem ( linear constraint ) : {x}_{MP} = {x}_{XP}^{*} \qquad ( 5 - 1 )$$

$$device constraint of combined heat and power system i ( nonlinear constraint ) : {A}_{i 3} {x}_{SPi}^{3} + {A}_{i 2} {x}_{SPi}^{2} + {A}_{i 1} {x}_{SPi} = {c}_{i} \qquad ( 5 - 2 )$$

$$device constraint of combined heat and power system i ( nonlinear constraint ) : {A}_{i 4} {x}_{SPi} = {c}_{i 4} \qquad ( 5 - 3 )$$

$$where$$

$$[ Formula 12 ]$$

$${ϕ}_{SPi} : objective function of subproblem i$$

$${x}_{SPi} : optimization variable vector of subproblem i$$

$${x}_{MP}^{*} : solution of master problem$$

The master problem expressed by the above formula (4) is a linear programming problem formed by a power system constraint and a device constraint of the EV, and determines an optimization variable vector x_{MP} (=the power generation amount of each DER in each time section) that minimizes the objective function ϕ_{MP}. The subproblem i is a nonlinear programming problem having a constraint of the combined heat and power system i, and determines an optimization variable vector x_{SPi} (=an operation plan of each device, such as a generator or a freezer, forming the combined heat and power system i) that minimizes the objective function ϕ_{SPi}. The subproblem i is solved with the solution of the master problem fixed (x_{MP}=x_{MP}*), where the solution of the master problem is x_{MP}*. However, the relationship expressed by the following formula (6) holds between the optimization variable vectors of the original problem, the master problem and the subproblem i.

$$[ Formula 13 ]$$

$$x = {x}_{MP} ⋃ {x}_{SP 1} ⋃ {x}_{SP 2} ⋃ … ⋃ {x}_{{SP}_{n}} \qquad ( 6 )$$

The above formula (6) shows that decomposing the optimization variable vector x of the original problem reduces the scale of the optimization problem of the master problem and the subproblem.

Since all the objective functions and constraint conditions of the master problem are linear, the linear programming method can be used. With the linear programming method, the solution can be determined in a few seconds even when there are millions of variables. Therefore, even if EVs rapidly proliferate, a vast number of EVs to be controlled can be handled.

The operation plan of the combined heat and power system i is generated by solving the optimization problem formulated as a subproblem i. The subproblem i corresponds to an optimization problem that generates an operation plan of a device (such as a generator or a freezer) in the combined heat and power system i. When there is a plurality of combined heat and power systems, there can be a plurality of subproblems. In the following, only a generalized subproblem i will be described. Although the combined heat and power system will be described as an example of a DER having nonlinear characteristics in embodiments described later, other DERs can also be used. Although at least any one of A, b and c in the subproblem i is a subordinate function of the solution of the master problem, the determined solution x_{MP}* of the master problem is used as a fixed value here.

In the master problem, the energy cost ϕᵢ of the combined heat and power system i in the objective function of the original problem is replaced with a new optimization variable θᵢ to remove the constraints of the combined heat and power system i. θᵢ is defined as expressed by the following formula (7) as an optimization variable that assumes a value equal to or larger than the energy cos t of the combined heat and power system i optimally operated. The only constraint relating to θᵢ in the master problem is the non-negativity condition, and the following formula (7) is not necessarily satisfied. In view of this, a constraint referred to as the Benders cut is added to limit the feasible area so that the following formula (7) holds.

$$[ Formula 14 ]$$

$${θ}_{i} \geq {min}_{x ∈ X} {Φ}_{{SP}_{i}} \qquad ( 7 )$$

$$where$$

$$[ Formula 15 ]$$

$$X : set of all possible solutions of optimization variable vector x$$

One effect of the Benders cut is to make it possible for the above formula (7) assumed for θᵢ to hold as described above. Another effect is to remove an inappropriate area of the objective function from the search area and promote convergence to an overall optimal solution.

A method of generating the Benders cut will be examined below. A dual problem (referred to as a DSPi hereinafter) of the subproblem i will be considered. The DSPi can be regarded as a problem that maximizes the lower limit value of the subproblem i, so that an objective function value ϕ_{DSPi} of the DSPi is equal to or smaller than an objective function value ϕ_{SPi} of the subproblem i. Therefore, the following formula (8) holds.

$$[ Formula 16 ]$$

$${min}_{x ∈ X} {Φ}_{{SP}_{i}} \geq {min}_{x ∈ X} {Φ}_{{DSP}_{i}} \qquad ( 8 )$$

$$where$$

$$[ Formula 17 ]$$

$${ϕ}_{DSPi} : objective function of dual problem of subproblem i$$

A difficulty lies in how to estimate the right side of the above formula (8). As a simple method, ϕ_{DSP} can be calculated one by one for all feasible solutions of x. However, such a method goes against the original objective of efficiently solving the problem by decomposing the problem into a master problem and a subproblem. Thus, the right side of the above formula (7) is estimated from the optimal solution ϕ_{DSP}* of the DSP provided that x_{MP}=x_{MP}*. An optimization variable determined as an optimal solution of the DSP is denoted as z*. z* is referred to as sensitivity information or shadow price, and indicates how much the objective function value is improved or deteriorated when each constraint is relaxed or tightened. Using the sensitivity information z*, the right side of the above formula (8) is estimated as shown by the following formula (9).

$$[ Formula 18 ]$$

$${min}_{x ∈ X} {Φ}_{{DSP}_{i}} ∼ {Φ}_{{DSP}_{i}}^{*} - {b}_{i}^{T} {z}^{*} \qquad ( 9 )$$

$$where$$

$$[ Formula 19 ]$$

$${Φ}_{{DSP}_{i}}^{*} : optimal solution {ϕ}_{DSPi} under condition that x = {x}^{⋆}$$

An inequality concerning θᵢ derived based on the above formula (9) is the Benders cut expressed by the following formula (10). By adding the Benders cut as a constraint condition of the master problem, the above formula (7) that defines θᵢ is satisfied. Based on the above discussion, in the Benders decomposition, an optimization problem is decomposed into a master problem and a subproblem.

$$[ Formula 20 ]$$

$${θ}_{i} \geq {Φ}_{{DSP}_{i}}^{*} - {b}_{i}^{T} {z}^{*} \qquad ( 10 )$$

As described above, sensitivity information z* is required to generate the Benders cut. However, the existing EMS only simply solves a problem corresponding to the subproblem and does not handle a dual problem, and therefore probably has no mechanism to output the sensitivity information z*

Thus, the sensitivity information calculation unit 104 in the DERMS 101 estimates the sensitivity information z*. There are two possible estimation methods described below.

In a first method, the sensitivity information calculation unit 104 solves the DSP. In this case, although the sensitivity information z* is determined, the DERMS 101 performs a computation similar to the computation performed by the EMS 111, and the calculation time probably increases.

In a second method, the sensitivity information x* is estimated by using input/output data exchanged between the DERMS 101 and the EMS 111. For example, to estimate the sensitivity information z*, a complementarity theory is used. The complementarity theory is a theory that indicates that (I) and (II) below are equivalent.
(I) The solution x of the master problem and the solution z of the dual problem are optimal solutions.
(II) The equality holds in any one of A^{T}z≤c and x≥0, and the equality holds in any one of Az≥c and z≥0.

Considering that the sensitivity information z* is an optimal solution of the DSP, as can be seen, the sensitivity information z* is determined from A, c and x according to (II) described above. Of these values, A and c can be obtained from the DER parameter estimation unit 103, and x can be obtained from the EMS 111.

The output combination computation unit 105 generates the Benders cut based on the sensitivity information z* estimated by the sensitivity information calculation unit 104, and outputs a searchable area of the master problem. Possible forms of the output include a list, a range and the like of output combinations of DERs, for example. In the course of iterative computation, the constraint condition due to the Benders cut is added, so that the list or range of combinations is reduced.

### <Search for Optimal Solution Using Benders Cut>

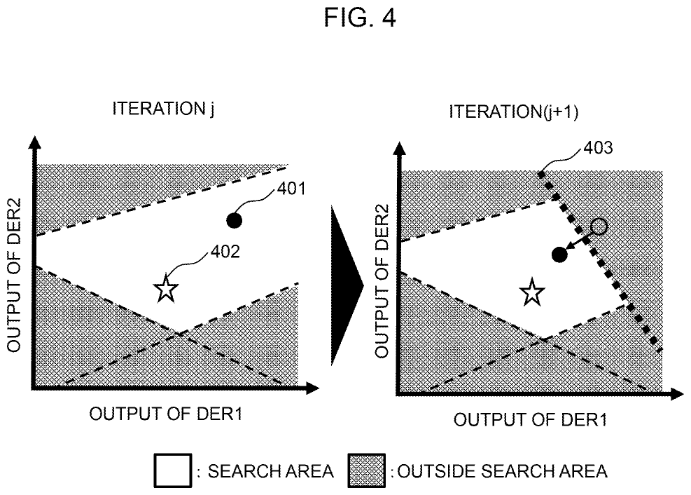

FIG. 4 is a diagram showing an example change of the search area due to the iterative computation using the Benders cut. FIG. 4 shows outputs of DERs, DER1 and DER2, on the horizontal axis and the vertical axis, and illustrates a problem of determining an optimal output combination of these DERs. As shown in the left half of FIG. 4, in the search area in an iteration j, a provisional solution 401 is falling into a local solution located at some distance from an optimal solution 402. As shown in the right half of FIG. 4, in the search area in an iteration (j+1), a Benders cut 403 is newly added as a constraint condition, and the search area is further narrowed down. As a result, the provisional solution 401 can jump out of the local solution and come closer to the optimal solution 402.

The DER group-based power generation amount calculation unit 106 calculates an optimal combination of output ranges from the range of output combinations. Specifically, the DER group-based power generation amount calculation unit 106 solves the optimization problem defined as the master problem. The optimization method can be not only the linear programming problem but also the internal point method or the genetic algorithm, for example.

The DER group-based power generation amount calculation unit 106 further calculates the upper bound (UB) and the lower bound (LB) of the optimal solution. Since the master problem corresponds to the original problem with some of the constraints relaxed, the obtained objective function value is probably smaller than the optimal solution. Therefore, as shown by the following formula (11), the objective function value ϕ_{MP} of the master problem corresponds to the lower bound LB.

$$[ Formula 21 ]$$

$$LB = {ϕ}_{MP} \qquad ( 11 )$$

On the other hand, the objective function values ϕ_{SPi} of the subproblems i correspond to the values of the first to n-th terms of the original problem. However, the subproblem is solved under conditions additionally including a constraint x_{MP}=x_{MP}*, so that the subproblem i has a lower degree of freedom than the original problem for which all the solutions including x_{MP} are optimized in a collective manner, and the objective function value is probably larger than the optimal solution. In addition, the objective function value ϕ_{SPi}* for the optimal solution of the subproblem approximately agrees with the objective function value ϕ_{SPi}* for the optimal solution of the DSPi. Accordingly, the total sum of ϕ_{DSPi}* (the sum of the first to n-th terms of the original problem) plus a value corresponding to the last term of the objective function (the second and following terms of the above formula (11)) is determined as the upper bound UB of the optimal solution.

$$[ Formula 22 ]$$

$$UB = {\sum }_{i = 1}^{n} {Φ}_{{DSP}_{i}}^{*} + LB - {\sum }_{i = 1}^{n} {Θ}_{i} \qquad ( 12 )$$

The objective function value of the provisional solution is the UB. The difference between the UB and the LB indicates the magnitude of a provisional error with respect to the optimal solution. In the course of iterative computation, the difference between the UB and the LB decreases, and the calculation is ended when the convergence condition 121 is satisfied.

### <Output of Upper and Lower Bounds 127 of Optimal Solution>

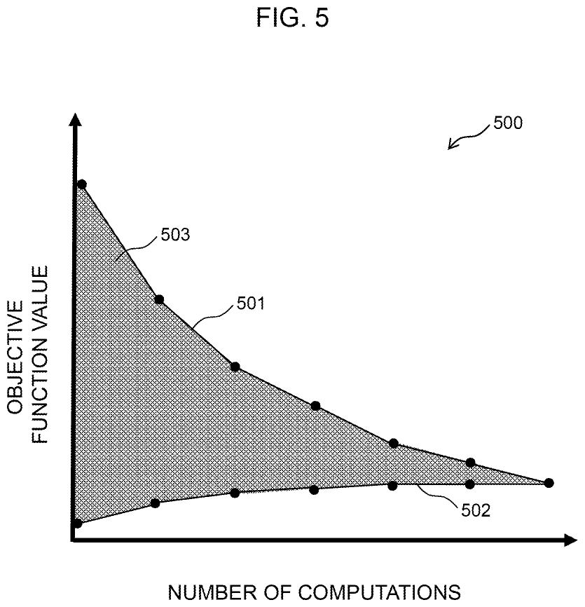

FIG. 5 is a diagram showing an example output of the upper and lower bounds 127 of the optimal solution. The UB and the LB can be used for not only convergence determination but also evaluation of the reliability of solutions, and therefore are output to the power distribution system operator 112 as the upper and lower bounds 127 of the optimal solution. A graph 500 shown in FIG. 5 can be displayed on a display unit (not shown) coupled to the DERMS 101 or a display unit (not shown) of a computer of the power distribution system operator 112. In the graph 500 in FIG. 5, the horizontal axis indicates the number of computations, and the vertical axis indicates the objective function value. As the number of computations increases, an UB 501 decreases, and an LB 502 increases. Accordingly, an error range 503 of the provisional solution 401 with respect to the optimal solution 402 defined by the difference between the UB and the LB decreases. Although the UB 501 and the LB 502 are output as a function of the number of computations as an example, the UB 501 and the LB 502 of the final solution or the UB 501 and the LB 502 for a solution for which the difference between the UB and the LB is equal to or smaller than a predetermined value that can assure the precision of the solution may be output.

### <Process of DERMS 101 According to Embodiment 1>

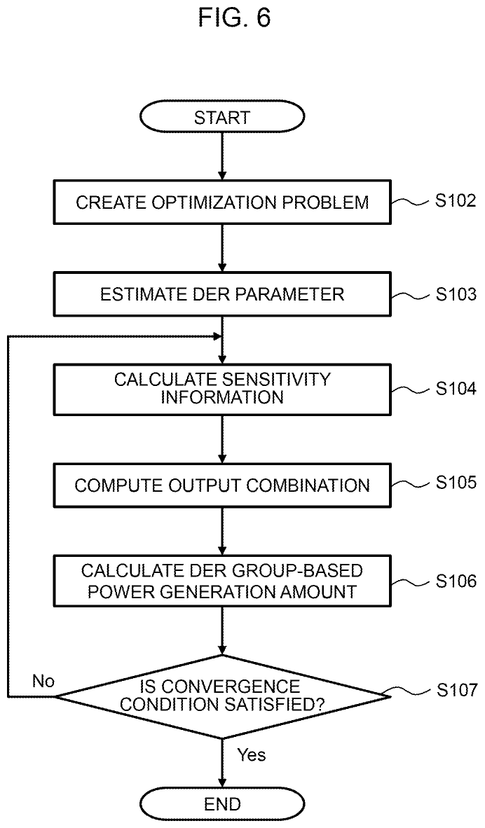

FIG. 6 is a flowchart showing an example process of the DERMS 101 according to the embodiment 1. Upon receiving the convergence condition 121 from the power distribution system operator 112, the DERMS 101 iteratively computes the power generation amount 122 of each DER and outputs the power generation amount 122 to the EMS until the convergence condition 121 is satisfied.

First, in Step S102, the optimization problem creation unit 102 creates an optimization problem with the parameters in the formula templates expressed by the above formulas (4) to (5) determined based on the power system topology information 131, the DER coupling busbar information 132 retained by the distribution power system operator and the facility information 123 on the DER to be controlled obtained from the EMS 111.

In Step S103, the DER parameter estimation unit 103 obtains the energy price/demand 124 and the operation plan 125 and the energy cost 126 of each DER from each EMS 111, and estimates the value of any parameter of the optimization problem that is not determined in the processing of Step S102.

In Step S104, the sensitivity information calculation unit 104 calculates an estimated value of the sensitivity information. In Step S105, the output combination computation unit 105 estimates the Benders cut expressed by the above formula (10) based on the sensitivity information. In Step S106, the DER group-based power generation amount calculation unit 106 solve the optimization problem expressed by the above formula (4) by setting the Benders cut estimated in Step S105 as a new constraint condition, thereby calculating the power generation amount 122 of each DER and the upper and lower bounds 127 of the solution.

In Step S107, the DER group-based power generation amount calculation unit 106 determines whether the convergence condition 121 is satisfied in Step S106. If the convergence condition 121 is satisfied (Yes in Step S107), the process of the DERMS 101 ends. If the convergence condition 121 is not satisfied (No in Step S107), the process proceeds to Step S104.

According to this embodiment, when solving an optimization problem that calculates an objective function value and an optimal solution that minimize an objective function for all distributed energy resources including distributed energy resources having linear characteristics and distributed energy resources having nonlinear characteristics, the optimization problem is decomposed into a master problem having linear constraints and a subproblem having nonlinear constraints. Then, a constraint condition estimated based on the sensitivity information in a dual problem of the subproblem is added to the master problem to reduce the search area for the optimal solution, so that the optimal solution or a solution close to the optimal solution can be quickly calculated.

In addition, since not only the operation plan of each DER group but also the upper and lower bounds of the optimal solution are output, the precision of the operation plan can be indicated to assure reliability.

### Embodiment 2

### <General Configuration of System Including DERMS 101B According to Embodiment 2>

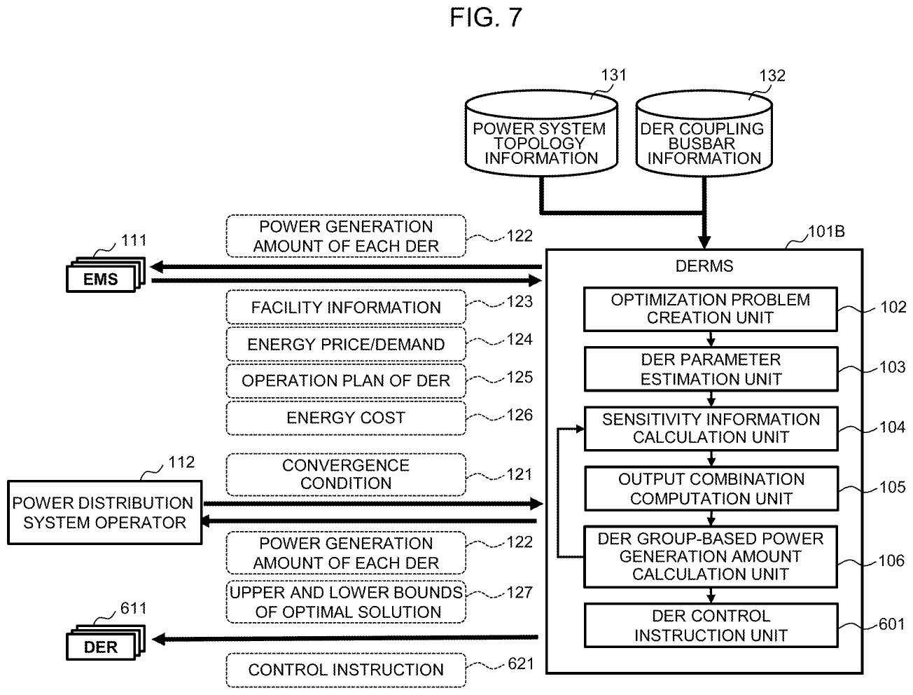

FIG. 7 is a block diagram showing an example general configuration of a system including a DERMS 101B according to an embodiment 2. The DERMS 101B according to the embodiment 2 further includes a DER control instruction unit 601, compared with the DERMS 101 according to the embodiment 1.

The DER control instruction unit 601 directly controls each DER 611 by outputting a control instruction 621, which depends on the power generation amount 122 of the DER that is output to the EMS 111, to the DER 611. There can be one or more DERs 611. The DER control instruction unit 601 may directly control some of the DERs to be controlled by the DERMS 101B.

### <Process of DERMS 101B According to Embodiment 2>

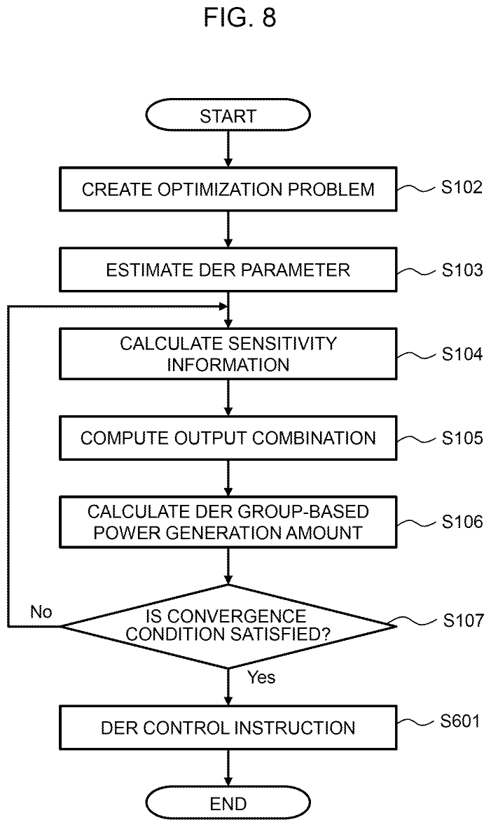

FIG. 8 is a flowchart showing an example process of the DERMS 101B according to the embodiment 2. The process of the DERMS 101B according to the embodiment 2 further includes DER control instruction processing of Step S601, compared with the process of the DERMS 101 according to the embodiment 1 (see FIG. 6).

In Step S601, the DER control instruction unit 601 outputs, to each DER 611 for which it is determined that the convergence condition 121 is satisfied in Step S107, a control instruction 621 that directly controls the DER 611 based on the power generation amount 122 of the DER.

### Embodiment 3

### <General Configuration of System Including DERMS 101C According to Embodiment 3>

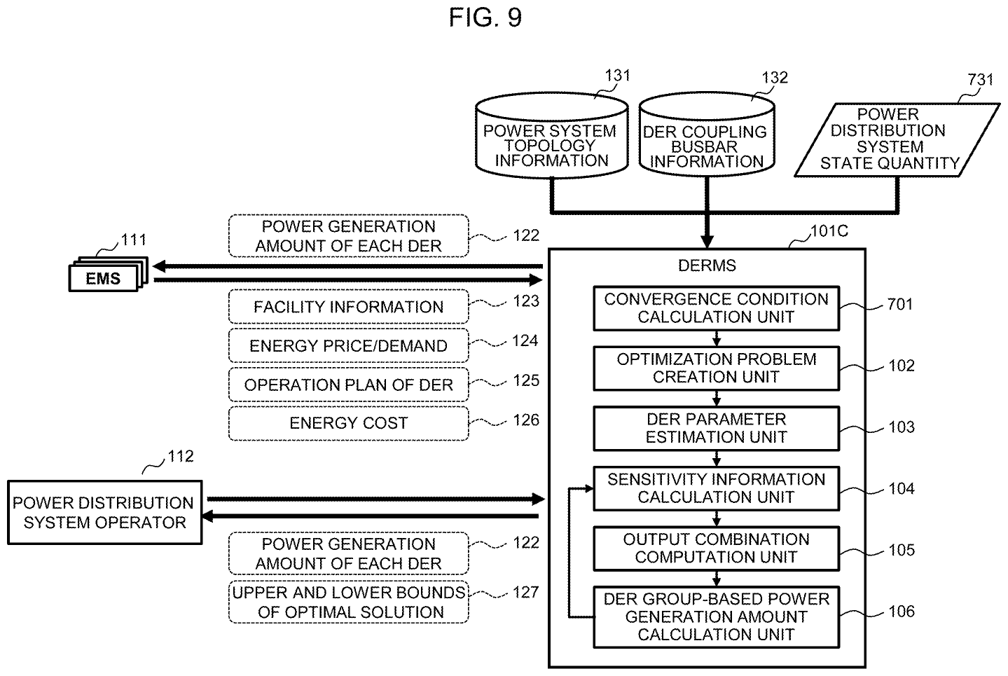

FIG. 9 is a block diagram showing an example general configuration of a system including a DERMS 101C according to an embodiment 3. The DERMS 101C according to the embodiment 3 further includes a convergence condition calculation unit 701, compared with the DERMS 101 according to the embodiment 1. As input data, a power distribution system state quantity 731 is further input to the DERMS 101C. While the convergence condition 121 is input from the power distribution system operator 112 in FIG. 1, according to the embodiment 3, no convergence condition 121 is input from the outside, and the DERMS 101c calculates the convergence condition 121 in itself.

While it is supposed in the embodiment 1 that the required solution precision as the convergence condition 121 is determined by the power distribution system operator 112, according to the embodiment 3, the power distribution system state quantity 731, such as voltage or frequency, is input as required, and the convergence condition calculation unit 701 automatically determine the convergence condition 121. For example, when the load variation is small or the voltage falls well within the threshold, the maximum calculation time, which is one of the convergence conditions 121, is set long so that an operation plan that provides as low energy cost as possible is searched for. On the other hand, in the event of an accident, when the load is rapidly changing, or when the voltage is close to the threshold, the maximum calculation time is set short since priority should be given to quickly issuing a control instruction.

As for the energy cost, which is another convergence condition 121, past operation plans of the power distribution system operator and costs therefor are stored in a table in association with the poser system states. For example, a convergence condition 121 is set that the new operation plan output by the DERMS 101C has to be lower in energy cost than the past operation plans under the condition of the same power distribution system state quantity 731. When no new operation plan is found that satisfies the set convergence condition 121 under the condition of the current power distribution system state quantity 731, the DERMS 101C outputs the past operation plan stored in the table in association with the same power distribution system state quantity 731 as it is.

### <Process of DERMS 101C According to Embodiment 3>

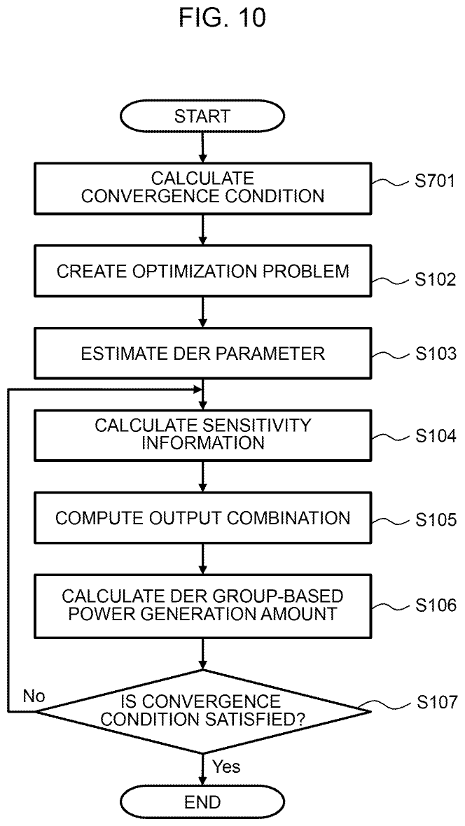

FIG. 10 is a flowchart showing an example process of the DERMS 101C according to the embodiment 3. The process of the DERMS 101C according to the embodiment 3 further includes convergence condition calculation processing of Step S701 before Step S102, compared with the process of the DERMS 101 according to the embodiment 1 (see FIG. 6). In Step S701, the convergence condition calculation unit 701 automatically sets the convergence condition 121 based on the power distribution system state quantity 731.

### <Computer Implementing DERMSs 101, 101B and 101C>

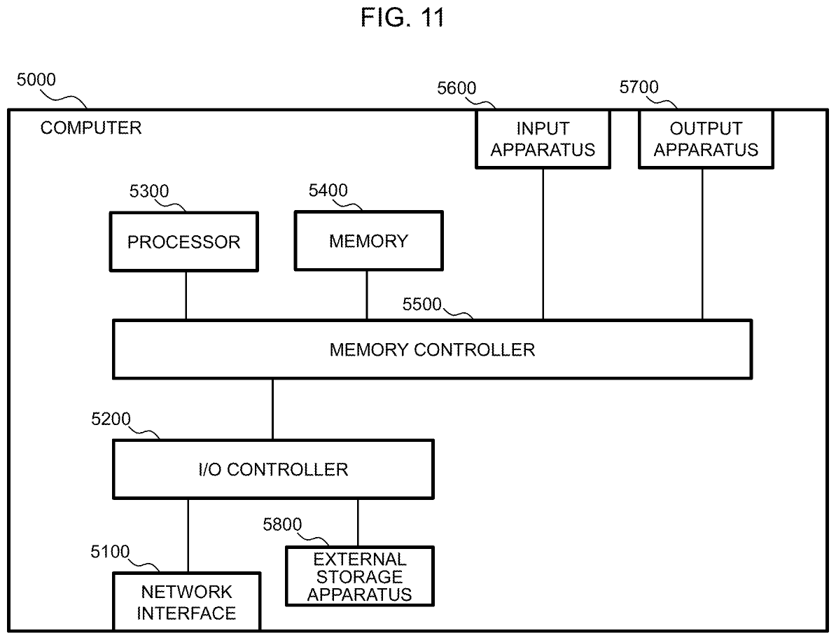

FIG. 11 is a diagram showing example hardware of a computer implementing the DERMS 101, 101B and 101C. A computer 5000 implementing the DERMS 101, 101B and 101C includes a central processing unit (CPU) or other processor 5300, a random access memory (RAM) or other memory 5400, an input apparatus 5600 (such as a keyboard, a mouse or a touch panel) and an output apparatus 5700 (such as a video graphic card coupled to an external display monitor) that are interconnected by a memory controller 5500. In the computer 5000, a program for implementing the DERMS is read from an external storage apparatus 5800, such as an SSD or an HDD, via an input/output (I/O) controller 5200 and executed by the processor 5300 and the memory 5400 cooperating with each other to implement the DERMS. Alternatively, each program for implementing the DERMS may be obtained from an external computer through communication via a network interface 5100. Alternatively, the program for implementing the DERMS may be stored in a portable storage medium, read by a medium reading apparatus, and executed by the processor 5300 and the memory 5400 cooperating with each other.

The present invention is not limited to the embodiments described above and includes various variations. For example, the above embodiments are described in detail in order to clearly describe the present invention and do not necessarily have all the components described. Some of the components of one of the embodiments can be replaced with a component of another embodiment, and a component of one of the embodiments can be added to another embodiment. Furthermore, some of the components of any of the embodiments can be added, omitted, replaced, integrated or distributed. The components and processing shown in the embodiments can be distributed, integrated or replaced as appropriate depending on the efficiency of implementation or processing.

### REFERENCE SIGNS LIST

101, 101B, 101C DERMS
102 optimization problem creation unit
103 DER parameter estimation unit
104 sensitivity information calculation unit
105 output combination computation unit
106 DER group-based power generation amount calculation unit
111 EMS
112 power distribution system operator
121 convergence condition
122 power generation amount of each DER
123 facility information
124 energy price/demand
125 operation plan of DER
126 energy cost
127 upper and lower bounds of optimal solution
131 power system topology information
132 DER coupling busbar information
601 DER control instruction unit
701 convergence condition calculation unit
731 power distribution system state quantity
5000 computer
5300 processor
5400 memory

1. A distributed energy resources management system, comprising:
an optimization problem creation unit that creates an optimization problem that minimizes or maximizes a cost index of distributed energy resources from power system topology information, coupling busbar information on the distributed energy resources, and facility information on the distributed energy resources obtained from an energy resources management system, and decomposes the optimization problem into a master problem having a linear constraint and a subproblem having a nonlinear constraint;
an output combination computation unit that estimates a new constraint condition for the master problem based on sensitivity information in a dual problem of the subproblem, adds the new constraint condition to a constraint condition of the master problem to limit a search area for a solution of the master problem, and computes a range of output combinations of distributed energy resources; and
a power generation amount calculation unit that solves an optimization problem defined as the master problem based on the range of output combinations computed by the output combination computation unit to calculate power generation amounts of the distributed energy resources, and outputs the calculated power generation amounts to the energy resources management system.

2. The distributed energy resources management system according to claim 1, wherein until a convergence condition is satisfied in calculation of the master problem,
iterative computations are performed in which
the output combination computation unit iteratively performs
a process of estimating a new constraint condition for the master problem based on sensitivity information in a dual problem of the subproblem, adding the new constraint condition to a constraint condition of the master problem to limit a search area for a solution of the master problem, and computing a range of output combinations of distributed energy resources, and
the power generation amount calculation unit iteratively performs
a process of solving the master problem based on the range of output combinations computed by the output combination computation unit to calculate power generation amounts of the distributed energy resources, and outputting the calculated power generation amounts to the energy resources management system.

3. The distributed energy resources management system according to claim 2, further comprising:
a parameter estimation unit that estimates, based on information obtained from the energy resources management system, a value of a parameter whose value is undetermined among parameters included in an objective function and a constraint condition of the master problem or the subproblem.

4. The distributed energy resources management system according to claim 3, further comprising:
a sensitivity information calculation unit that calculates the sensitivity information based on a parameter included in an objective function and a constraint condition of the master problem or the subproblem and information obtained from the energy resources management system.

5. The distributed energy resources management system according to claim 2, further comprising:
a convergence condition calculation unit that calculates the convergence condition based on a power distribution system state quantity.

6. The distributed energy resources management system according to claim 2, wherein the power generation amount calculation unit
further outputs an upper bound and a lower bound of an optimal solution of the master problem that indicate a precision of the power generation amounts of the distributed energy resources calculated from the master problem along with the calculated power generation amounts of the distributed energy resources.

7. The distributed energy resources management system according to claim 6, wherein the power generation amount calculation unit
outputs the power generation amounts of the distributed energy resources calculated from the master problem and the upper bound and the lower bound of the optimal solution of the master problem in each of the iterative computations as a calculation log.

8. The distributed energy resources management system according to claim 1, further comprising:
a control instruction unit that controls the distributed energy resources based on the power generation amounts of the distributed energy resources calculated by the power generation amount calculation unit.

9. A distributed energy resources management method performed by a distributed energy resources management system, comprising:
processing in which an optimization problem creation unit of the distributed energy resources management system creates an optimization problem that minimizes or maximizes a cost index of distributed energy resources from power system topology information, coupling busbar information on the distributed energy resources, and facility information on the distributed energy resources obtained from an energy resources management system, and decomposes the optimization problem into a master problem having a linear constraint and a subproblem having a nonlinear constraint;
processing in which an output combination computation unit of the distributed energy resources management system estimates a new constraint condition for the master problem based on sensitivity information in a dual problem of the subproblem, adds the new constraint condition to a constraint condition of the master problem to limit a search area for a solution of the master problem, and computes a range of output combinations of distributed energy resources; and
processing in which a power generation amount calculation unit of the distributed energy resources management system solves an optimization problem defined as the master problem based on the range of output combinations computed by the output combination computation unit to calculate power generation amounts of the distributed energy resources, and outputs the calculated power generation amounts to the energy resources management system.

10. The distributed energy resources management system according to claim 2, further comprising:
a control instruction unit that controls the distributed energy resources based on the power generation amounts of the distributed energy resources calculated by the power generation amount calculation unit.

11. The distributed energy resources management system according to claim 3, further comprising:
a control instruction unit that controls the distributed energy resources based on the power generation amounts of the distributed energy resources calculated by the power generation amount calculation unit.

12. The distributed energy resources management system according to claim 4, further comprising:
a control instruction unit that controls the distributed energy resources based on the power generation amounts of the distributed energy resources calculated by the power generation amount calculation unit.

13. The distributed energy resources management system according to claim 5, further comprising:
a control instruction unit that controls the distributed energy resources based on the power generation amounts of the distributed energy resources calculated by the power generation amount calculation unit.

14. The distributed energy resources management system according to claim 6, further comprising:
a control instruction unit that controls the distributed energy resources based on the power generation amounts of the distributed energy resources calculated by the power generation amount calculation unit.

15. The distributed energy resources management system according to claim 7, further comprising:
a control instruction unit that controls the distributed energy resources based on the power generation amounts of the distributed energy resources calculated by the power generation amount calculation unit.
